(19) United States
(12) Patent Application Publication
(10) Pub. No.: US 2026/0307794 A1
(43) Pub. Date: Oct. 8, 2026

(54) Lavatory Translating Wall Latch System

(71) Applicant: B/E Aerospace, Inc., Winston Salem, NC (US)

(72) Inventors: Geoffrey L. Eisenhardt, Phoenix, AZ (US); Patrick Michael Quinn, Winston-Salem, NC (US); Travis John Vaninetti, Bothell, WA (US)

(73) Assignee: B/E Aerospace, Inc., Winston Salem, NC (US)

(21) Appl. No.: 19/636,641

(22) Filed: Apr. 1, 2026

Related U.S. Application Data
(60) Provisional application No. 63/783,765, filed on Apr. 4, 2025.

(51) Int. Cl. B64D 11/00; E05C 9/04; E05C 9/06

(52) U.S. Cl. CPC B64D 11/0023; E05C 9/042; E05C 9/063

(57) ABSTRACT

Translation of a center wall converts an aircraft lavatory between a dual lavatory configuration and a single lavatory configuration. A latch system for the center wall may have a handle configured to operate a plurality of latches simultaneously. The handle may be disposed on a front edge of the center wall. The latch system may comprise an internal plate and a longitudinal member translatable with respect to the internal plate. A first vertical rod and a second vertical rod may extend from the internal plate to a ceiling latch and a floor latch, respectively. A horizontal rod may extend from the internal plate to a rear latch. Operation of the handle may translate the longitudinal member, which may, in turn, translate each of the first vertical rod, the second vertical rod, and the horizontal rod to operate the ceiling latch, the floor latch, and the rear latch, respectively.

### CROSS REFERENCE TO RELATED APPLICATIONS

This application claims the benefit of and priority to U.S. Provisional Application No. 63/783,765, entitled “LAVATORY TRANSLATING WALL LATCH SYSTEM,” filed on Apr. 4, 2025, which is hereby incorporated by reference in its entirety for all purposes.

### TECHNICAL FIELD

The present disclosure generally relates to lavatory systems and, more particularly, to adaptable lavatory solutions for aircraft lavatories.

### BACKGROUND

Aircraft lavatories may be difficult to access for passengers who use wheelchairs or other mobility devices. Space constraints in aircraft design tend to lead to designs that may not fully account for the needs of passengers who use wheelchairs or other mobility devices. Lavatories are typically equipped with narrow doorways. This presents not only a greater challenge for those with mobility impairments but may also be insurmountable for some. Wheelchair users are at a particular disadvantage as they may need to abandon their wheelchair outside the lavatory and navigate their body through the same narrow opening, increasing the difficulty for both passengers and crew.

Current design solutions, which utilize retractable and rotating walls to convert two centerline lavatories into one, may rely on latches accessible from one side of a lavatory center wall, increasing a risk of tampering or access by a passenger in a single side of the lavatory. Conventional latches may be disposed in awkward or difficult-to-reach locations. Further, latches which must be accessed from a side of the door may be associated with moving from one side of the door to the other in narrow spaces to unlatch complex latch systems. Latches disposed proximate the floor of the lavatory may be exposed to unsanitary conditions.

### SUMMARY

A latch system is disclosed. The latch system may comprise an internal plate; a longitudinal member coupled to the internal plate; a handle operably coupled to the longitudinal member such that the longitudinal member is configured to translate in response to operation of the handle; and a first vertical rod operably coupled to the longitudinal member, the first vertical rod terminating in a first pawl, wherein, in response to operation of the handle, the first pawl may be extended and retracted with respect to the longitudinal member.

In various embodiments, the latch system may further comprise a center wall having a perimeter defined by a front edge, a rear edge, a ceiling edge, and a floor edge, wherein, in response to operation of the handle, the first pawl may be extended from the perimeter of the center wall and retracted within the perimeter of the center wall.

In various embodiments, the handle may form at least a portion of the front edge of the center wall.

In various embodiments, the internal plate may define a first angled slot and the first vertical rod is coupled to the internal plate via a first post extending through the first angled slot such that, in response to operation of the handle, the first angled slot guides translation of the first vertical rod.

In various embodiments, the latch system may further comprise a first claw coupling the longitudinal member to the first post.

In various embodiments, the latch system may further comprise a second vertical rod operably coupled to the longitudinal member, terminating in a second pawl, and extending from the longitudinal member in an opposing direction from the first vertical rod.

In various embodiments, the internal plate may define a second angled slot and the second vertical rod may be coupled to the internal plate via a second post extending through the second angled slot such that, in response to operation of the handle, the second angled slot guides translation of the second vertical rod.

In various embodiments, the latch system may further comprise a horizontal rod operably coupled to the longitudinal member, terminating in a third pawl, and extending from the longitudinal member in a direction perpendicular to the first vertical rod.

An aircraft lavatory is disclosed. The aircraft lavatory may comprise a center wall having a perimeter defined by a front edge, a rear edge, a ceiling edge, and a floor edge; a first latch disposed on the ceiling edge and comprising a first pawl configured to extend from and retract into the ceiling edge; a second latch disposed on the rear edge and comprising a second pawl configured to extend from and retract into the rear edge; and a handle disposed on the front edge and configured to simultaneously operate the first latch and the second latch through a mechanical linkage comprising a longitudinal member that translates in response to actuation of the handle.

In various embodiments, the aircraft lavatory may further comprise an internal plate coupled to the handle; a first vertical rod operably coupling the first pawl to the internal plate; and a horizontal rod operably coupling the second pawl to the internal plate.

In various embodiments, in response to pulling the handle in a first direction away from the front edge of the center wall, the first pawl may be translated in a second direction perpendicular to the first direction such that the first pawl is retracted within the ceiling edge.

In various embodiments, in response to pulling the handle in the first direction away from the front edge of the center wall, the second pawl may be translated in the first direction such that the second pawl may be retracted within the rear edge.

In various embodiments, in response to pushing the handle in a third direction opposite the first direction toward the front edge of the center wall, the first pawl may be translated in a fourth direction opposite the second direction such that the first pawl is extended from the ceiling edge and the second pawl may be translated in the third direction such that the second pawl is extended from the rear edge.

In various embodiments, in response to retraction of the first pawl and the second pawl, the center wall may be free to translate within the aircraft lavatory.

An aircraft lavatory is disclosed. The aircraft lavatory may comprise a first single lavatory; a second single lavatory, wherein the aircraft lavatory is convertible between a dual lavatory configuration in which each of the first single lavatory and the second single lavatory are individually accessible and a single lavatory configuration in which the first single lavatory and the second single lavatory are accessible as an expanded lavatory; a floor extending across the first single lavatory and the second single lavatory; a ceiling extending across the first single lavatory and the second single lavatory; a rear wall extending across the first single lavatory and the second single lavatory; a center wall configured to separate the first single lavatory from the second single lavatory in the dual lavatory configuration and configured to translate within the aircraft lavatory to convert the first single lavatory and the second single lavatory into the single lavatory configuration; and a latch system for latching the center wall into a center position in the dual lavatory configuration. In various embodiments, the latch system may comprise a first latch for coupling the center wall to the ceiling of the aircraft lavatory, a second latch for coupling the center wall to the rear wall of the aircraft lavatory, and a handle configured to simultaneously operate the first latch and the second latch through mechanical actuation, wherein actuation of the handle causes coordinated extension or retraction of pawls of the first latch and the second latch.

In various embodiments, the handle may be coupled to a midsection of the center wall and may be inaccessible in response to either a first door of the first single lavatory or a second door of the second single lavatory being in a closed position.

In various embodiments, the handle may be disposed on a front edge of the center wall.

In various embodiments, the ceiling may comprise a first channel for receiving a first pawl of the first latch. In various embodiments, the rear wall may comprise a second channel for receiving a second pawl of the second latch.

In various embodiments, the first pawl may be configured to extend from the center wall into the first channel and the second pawl is configured to extend into the second channel in response to pushing the handle in a first direction toward the center wall. In various embodiments, the first pawl may be configured to retract into the center wall and the second pawl may be configured to retract into the center wall in response to pulling the handle in a second direction away from the center wall.

In various embodiments, the aircraft lavatory may further comprise a third latch for coupling the center wall to the floor of the aircraft lavatory. In various embodiments, the handle the configured to operate the first latch, the second latch, and the third latch simultaneously.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments;

FIG. 2 illustrates an aircraft floorplan, in accordance with various embodiments;

FIG. 3 illustrates a front view of a lavatory, in accordance with various embodiments;

FIG. 4 illustrates a left perspective view of a lavatory, in accordance with various embodiments;

FIG. 5 illustrates a right perspective view of a lavatory, in accordance with various embodiments;

FIG. 6 illustrates a lavatory, in accordance with various embodiments;

FIG. 7 illustrates a lavatory, in accordance with various embodiments;

FIG. 8 illustrates a latch receiver of the lavatory of FIG. 7, in accordance with various embodiments;

FIGS. 9A and 9B illustrate a handle, in accordance with various embodiments;

FIG. 10 illustrates an internal latch system, in accordance with various embodiments;

FIGS. 11A and 11B illustrates a handle system, in accordance with various embodiments; and

FIG. 12 illustrates a latch, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion. As used herein “rear” refers to the direction of the lavatory opposing the lavatory doors (e.g. toward the fuselage wall). As used herein “front” refers to the direction of the lavatory facing the lavatory doors (e.g. toward the lavatory entrance).

Conventional adaptable lavatory solutions may have a translatable, foldable, or removable center wall for converting a lavatory between a dual lavatory configuration and a single lavatory configuration. The center wall is often secured by latches disposed on either side of the center wall. In this case, latching and unlatching the latches may require excessive crew member effort to operate the latches from each side of the center wall. Further latches accessible from the inside of the lavatory may increase a risk of passengers impermissibly accessing the latches. The center wall is often secured at least in part by floor level latches. The floor of an aircraft lavatory may be at risk of exposure to various contaminants. The center wall is often secured at least in part by ceiling level latches which may be difficult to reach by some crew members.

The latch system disclosed herein, in various embodiments, is not accessible from the inside of the lavatory. The latch system disclosed herein, in various embodiments, is accessible from a door frame of the lavatory. The latch system disclosed herein, in various embodiments, is operable from a central region of the center wall, rather than a floor or a ceiling of the lavatory. The latch system disclosed herein, in various embodiments, may be operable from a single location rather than various individual locations.

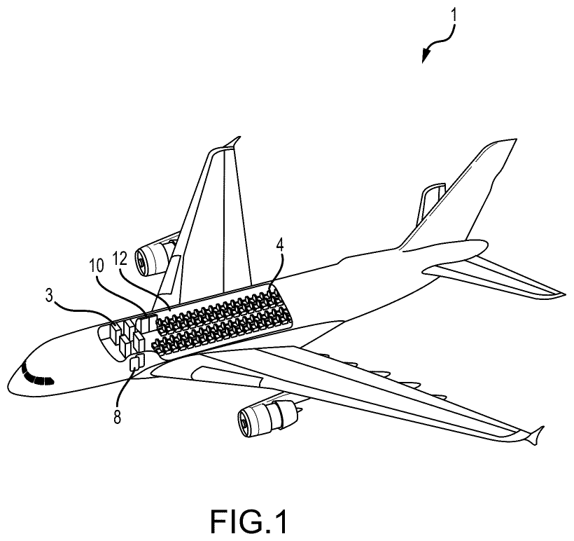

With initial reference to FIG. 1, an aircraft 1 is illustrated, in accordance with various embodiments. Aircraft 1 may comprise an aisle 6. Aircraft 1 may comprise a plurality of seats 4. Aircraft 1 may comprise one or more lavatories 10. While illustrated as a central outboard lavatory, it should be understood that lavatory 10 may be a forward lavatory, an aft lavatory, a central lavatory, an outboard lavatory, or an inboard lavatory. Aircraft 1 may comprise a door 8. Aircraft 1 may comprise a wheelchair plinth 2. Wheelchair plinth 2 may be disposed proximate door 8. In various embodiments, aircraft 1 is a narrowbody aircraft having only one aisle 6.

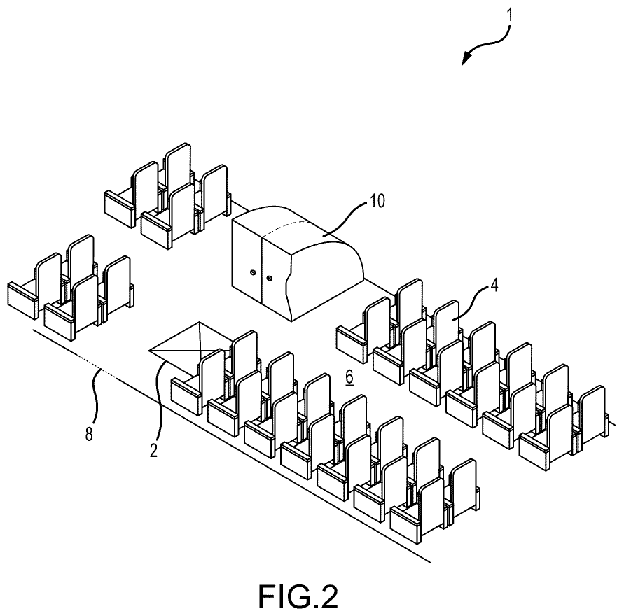

With initial reference to FIG. 2, a floor plan of aircraft 1 is illustrated, in accordance with various embodiments. As illustrated, wheelchair plinth 2 is disposed proximate lavatory 10. As illustrated, lavatory 10 is disposed proximate door 8. However, it should be understood that wheelchair plinth 2 may be spaced from lavatory 10.

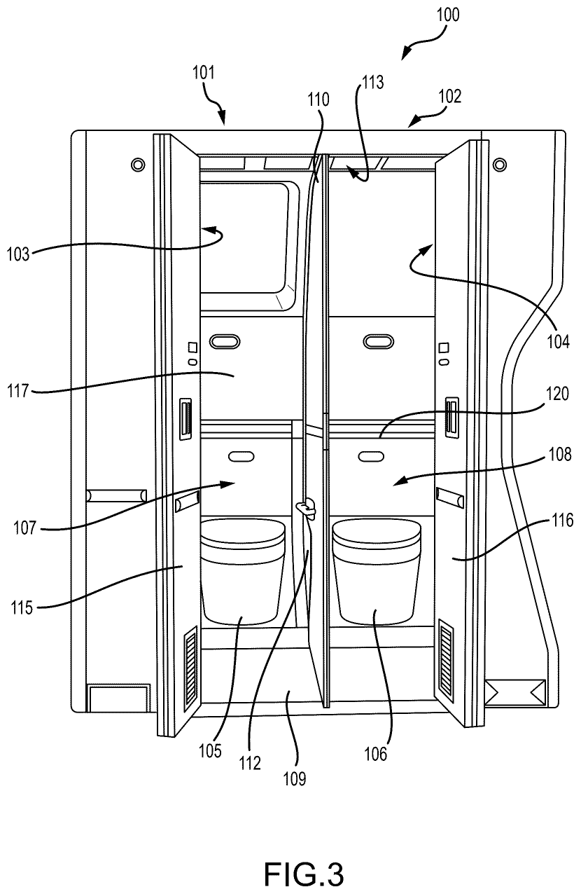

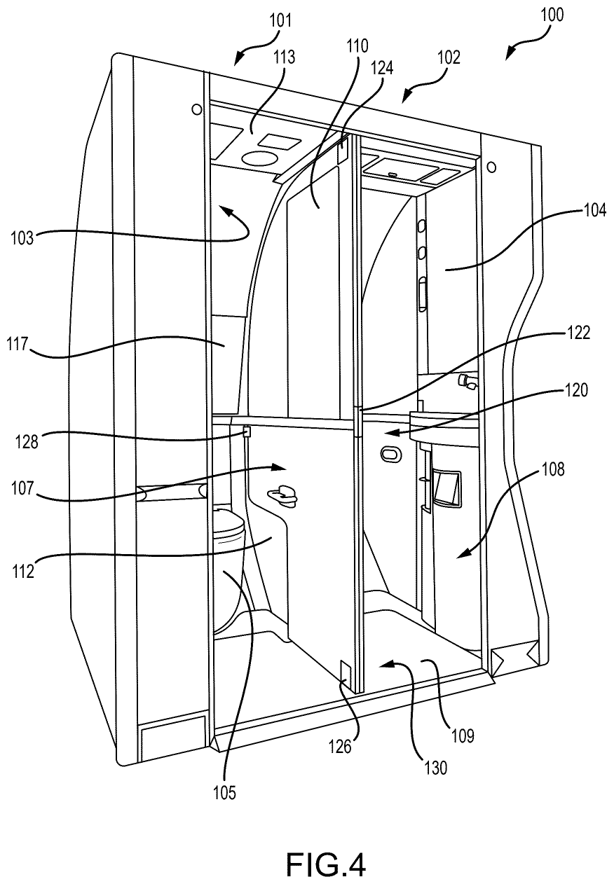

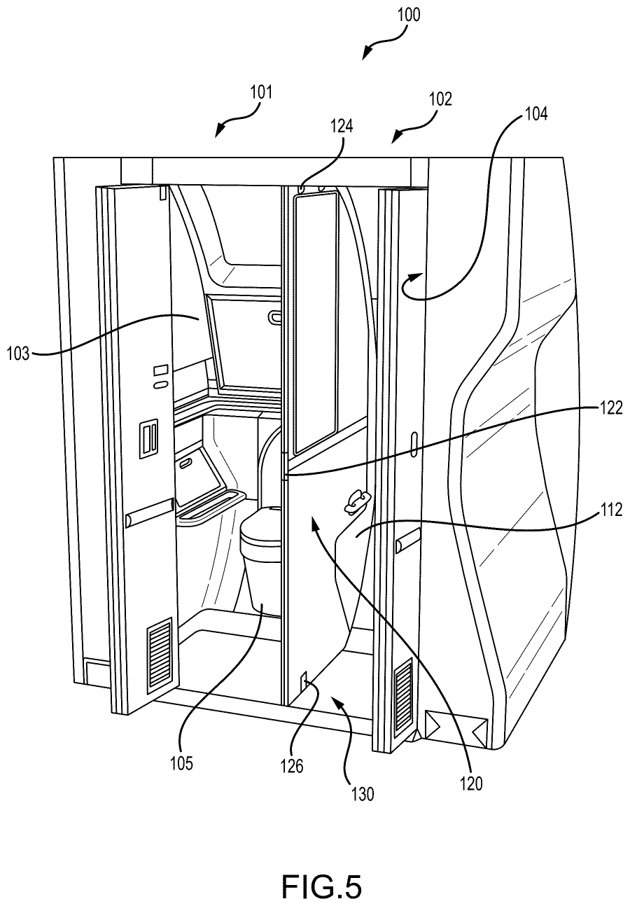

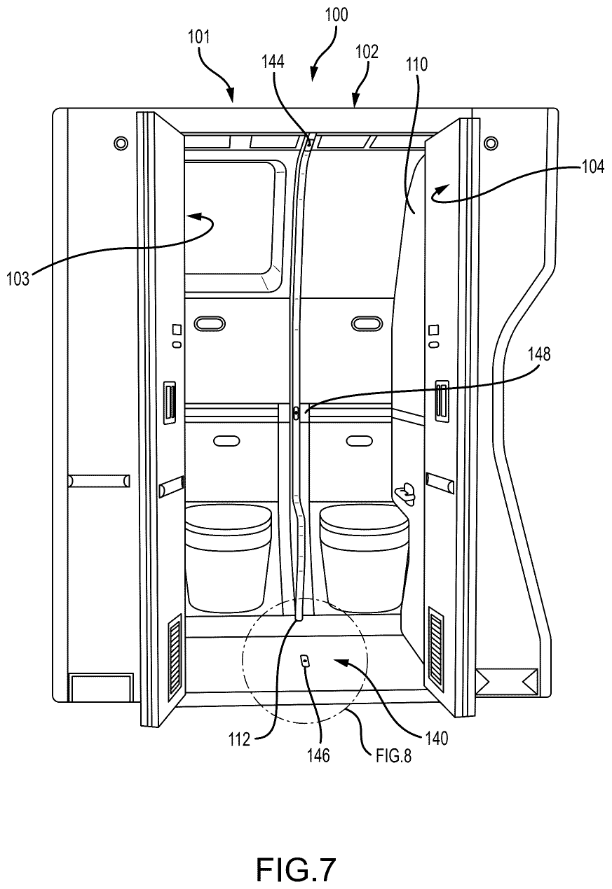

With reference to FIGS. 3-7, an aircraft lavatory 100 is illustrated. Aircraft lavatory 100 may be similar to lavatory 10. Aircraft lavatory 100 may be an adaptable lavatory. Aircraft lavatory 100 may be convertible between a dual lavatory configuration in which two single-stall lavatories are individually accessible (as illustrated in FIG. 3), and a single lavatory configuration in which only a single expanded lavatory is accessible (as best illustrated in FIG. 7). In various embodiments, aircraft lavatory 100 may comprise a first single lavatory 101 and a second single lavatory 102. In various embodiments, aircraft lavatory 100 may comprise a first wall 103. The second single lavatory 102 may comprise a second wall 104. The first single lavatory 101 may comprise a first toilet 105. The second single lavatory 102 may comprise a second toilet 106. In various embodiments, aircraft lavatory 100 comprises a center wall 110. In various embodiments, the aircraft lavatory 100 may comprise a ceiling 113. Ceiling 113 may extend across the first single lavatory 101 and the second single lavatory 102. In various embodiments, the aircraft lavatory 100 may comprise a floor 109. Floor 109 may extend across the first single lavatory 101 and the second single lavatory 102. In various embodiments, the aircraft lavatory 100 may comprise a rear wall 117 extending across the first single lavatory 101 and the second single lavatory 102. In various embodiments, the first single lavatory 101 may comprise a first doorway 107 and the second single lavatory 102 may comprise a second doorway 108. In various embodiments, first single lavatory 101 may comprise a first door 115 and the second single lavatory 102 may comprise a second door 116.

In various embodiments, aircraft lavatory may comprise a partial divider 112. The center wall 110 may be selectively coupled to the partial divider 112. In various embodiments, the center wall 110 may be slidable, removeable, foldable, or otherwise convertible such that aircraft lavatory 100 may be convertible between a single lavatory configuration and a dual lavatory configuration. As shown in FIGS. 3-6, the center wall 110 may be coupled to the partial divider 112 to place the aircraft lavatory 100 in a dual lavatory configuration. As shown in FIG. 7, the center wall 110 may be disconnected from the partial divider 112 and translated to either one of the first wall 103 or the second wall 104 to place the aircraft lavatory 100 in a single lavatory configuration with increased space.

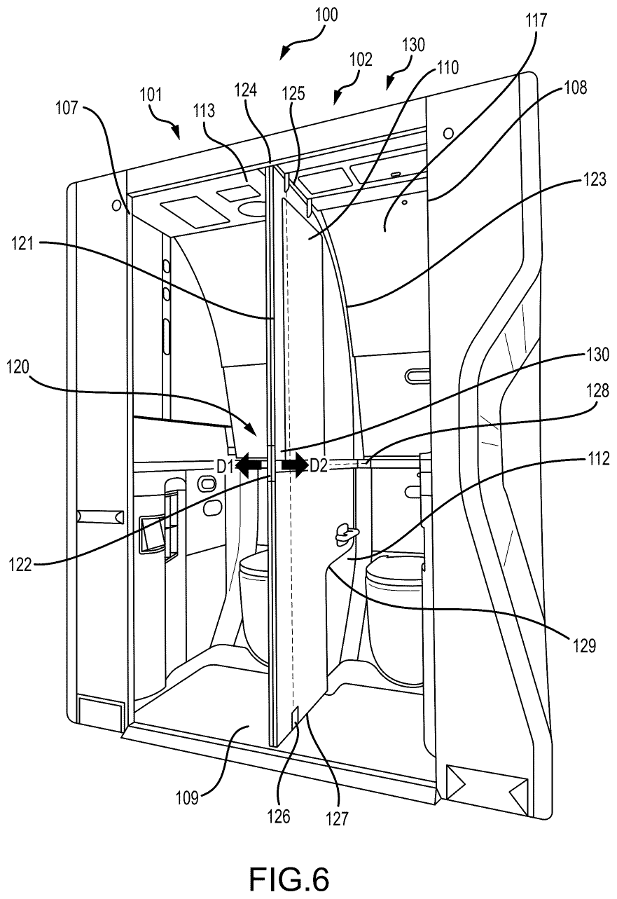

In various embodiments and as best shown in FIG. 6, the center wall 110 may have a perimeter defined by a front edge 121, a rear edge 123, a ceiling edge 125, and a floor edge 127. In various embodiments, the rear edge 123 may comprise a cutout 129 to accommodate a partial divider 112 or other attachment device. The front edge 121 may be disposed proximate the first doorway 107 and the second doorway 108. The rear edge 123 may be disposed proximate the rear wall 117. The ceiling edge 125 may be disposed proximate the ceiling 113. The floor edge 127 may be disposed proximate the floor 109. While the center wall 110 is illustrated as a single panel, the disclosure is not limited in this regard. The center wall 110 may comprise multiple panels, may be an accordion-style foldable door, or any other style door.

In various embodiments, the center wall 110 is configured to seal the first single lavatory 101 and the second single lavatory 102 in response to the aircraft lavatory 100 being in the dual lavatory configuration. The front edge 121 may be configured to seal the first doorway 107 from the second doorway 108 in response to one of the first door 115 or the second door 116 being in a closed position. In various embodiments, the front edge 121 of the center wall 110 extends across a junction between the first doorway 107 and the second doorway 108 such that, in response to either of the first door 115 or the second door 116 being closed, the closed door overlaps or abuts the front edge 121, thereby blocking access to the handle 122. In this manner, the handle 122 may only be accessible in response to both the first door 115 and the second door 116 being in an open position. This configuration prevents passengers within either single lavatory from accessing the handle 122 while the door is closed, thereby preventing unauthorized operation of the latch system 120. The rear edge 123 may contact the rear wall 117. The ceiling edge 125 may contact the ceiling 113. The floor edge 127 may contact the floor 109.

In various embodiments, center wall 110 may comprise a latch system 120. In various embodiments, the latch system 120 may be configured to operate the center wall 110 between the dual lavatory configuration and the single lavatory configuration. In various embodiments, the latch system 120 may be configured to secure the center wall 110 in a center position when the lavatory is in the dual lavatory configuration and release the center wall 110 from the center position to convert the lavatory to the single lavatory configuration. The latch system 120 operates by mechanically linking a centrally located handle 122 to a plurality of latches 130 via rigid rods. In operation, in response to the handle 122 being actuated (e.g., pulled or pushed), this motion is transmitted through the rigid rods to extend or retract pawls 152 of the latches 130. This mechanical linkage ensures coordinated operation of latches 130 regardless of whether the latch system 120 includes two, three, or more latches 130.

In various embodiments, the latch system 120 may comprise one or more latches 130. The latches 130 may comprise one or more ceiling latch 124. In various embodiments, the latches 130 may comprise one or more floor latch 126. In various embodiments, the latches 130 may comprise one or more rear latch 128. In various embodiments, the latches 130 may comprise each of a ceiling latch 124, a floor latch 126, and a rear latch 128. However, the disclosure is not limited in this regard. The latches 130 may comprise any combination of a ceiling latch 124, a floor latch 126, and a rear latch 128.

In various embodiments, the latch system 120 may comprise a handle 122. The handle 122 may be disposed at a midsection 131 of the front edge 121. The midsection 131 may be between the ceiling edge 125 and the floor edge 127. The handle 122 may be disposed between 2 feet and 5 feet from the floor 109. The handle 122 may be disposed between 2.5 feet and 4.5 feet from the floor 109. The handle 122 may be disposed between 3 feet and 4 feet from the floor 109. In various embodiments, the handle 122 may be disposed at approximately 3.5 feet (~1 m) from the floor 109, corresponding to a height that is ergonomically accessible to crew members of varying heights and to passengers using wheelchairs. The handle 122 is configured to translate in a direction substantially perpendicular to the plane of the center wall 110.

In various embodiments, the handle 122 is operable to latch and/or release each latch 130 of the latch system 120 (for example, each of the ceiling latch 124, the floor latch 126, and the rear latch 128) simultaneously. The simultaneous operation is achieved through rigid mechanical coupling between the handle 122 and each latch 130 via the internal latch system 150, as described further herein. In various embodiments, in response to the handle 122 being pulled away from the front edge 121 in a first direction D1 (substantially perpendicular to the plane of the center wall 110 and toward the first doorway 107 or second doorway 108), each latch 130 in the latch system 120 (for example, each of the ceiling latch 124, the floor latch 126, and the rear latch 128) is released by retraction of the pawls 152 into the center wall 110. In various embodiments, in response to the handle 122 being pushed toward the front edge 121 in a second direction D2 (opposite the first direction D1 and into the plane of the center wall 110), each latch 130 in the latch system 120 (for example, each of the ceiling latch 124, the floor latch 126, and the rear latch 128) is latched by extension of the pawls 152 from the center wall 110. In this manner, the handle 122 may control each latch 130 of the latch system 120 in a single action and at an ergonomic and/or sanitary height.

With respect to FIG. 7, aircraft lavatory 100 is illustrated in a single lavatory configuration. In response to handle 122 being pulled in the first direction D1 and the latches of latch system 120 being released (i.e., the pawls 152 being retracted into the center wall 110), the center wall 110 may be free to translate between various lateral positions within the first single lavatory 101 and the second single lavatory 102. The center wall 110 may translate along tracks, rails, or guides disposed on the floor 109 and/or ceiling 113 to facilitate smooth lateral movement. As shown in FIG. 7, the center wall 110 may be disconnected from the partial divider 112 and translated toward the second wall 104 to place the aircraft lavatory 100 in the single lavatory configuration. While illustrated as translated toward the second wall 104, it should be understood that the center wall 110 may be translated toward the first wall 103 in various embodiments. Once the center wall 110 is in a desired lateral position (e.g., adjacent to the first wall 103 or the second wall 104), the handle 122 may be pushed in the second direction D2 to extend the pawls 152 into corresponding latch receivers (not shown) disposed at the lateral position, thereby securing the center wall 110 in the single lavatory configuration. The single lavatory configuration may be an adaptable lavatory with increased space. The increased space may be beneficial for a passenger using a wheelchair or other mobility device.

In various embodiments, the latch system 120 may comprise one or more latch receiver 140. Each latch receiver 140 is configured to receive a latch 130. The latch receivers 140 may comprise one or more ceiling latch receiver 144. In various embodiments, the latch receivers 140 may comprise one or more floor latch receiver 146. In various embodiments, the latch receivers 140 may comprise one or more rear latch receiver 148. In various embodiments, the latch receivers 140 may comprise each of a ceiling latch receiver 144, a floor latch receiver 146, and a rear latch receiver 148. However, the disclosure is not limited in this regard. The latch receivers 140 may comprise any combination of a ceiling latch receiver 144, a floor latch receiver 146, and a rear latch receiver 148.

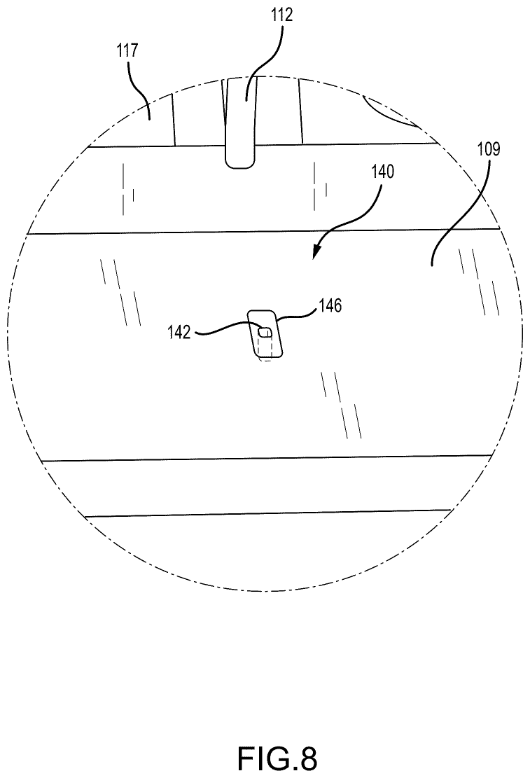

With respect to FIG. 8, an enlarged view of a latch receiver 140 is illustrated. While illustrated as the floor latch receiver 146, it should be understood that ceiling latch receiver 144 and rear latch receiver 148 may be similar to floor latch receiver 146. Each latch receiver 140 may comprise channel 142 extending perpendicularly into the surface on which latch receiver 140 is disposed. For example, a channel 142 of the floor latch receiver 146 may extend perpendicularly into the floor 109. For example, a channel 142 of the rear latch receiver 148 may extend perpendicularly into the partial divider 112 (or, in various embodiments, a rear structure or rear wall). For example, a channel 142 of the ceiling latch receiver 144 may extend perpendicularly into the ceiling 113. Each channel 142 may be configured to receive a pawl 152 of a latch 130, described further herein.

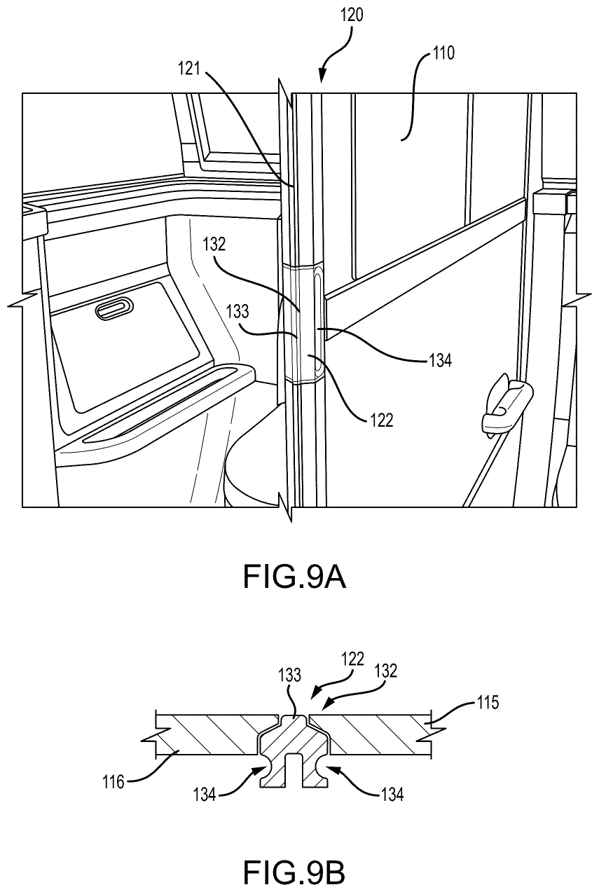

With respect to FIGS. 9A and 9B, handle 122 is illustrated. The handle 122 may have a beveled profile 132. The beveled profile 132 may comprise a front protrusion 133. The front protrusion 133 may form a seal between the front edge 121 of the center wall 110 and one or both of the first door 115 and the second door 116. The handle 122 may comprise a finger grip 134 on either side of the handle 122. The finger grips 134 may be depressions extending into the handle 122 to facilitate gripping the handle 122 during operation.

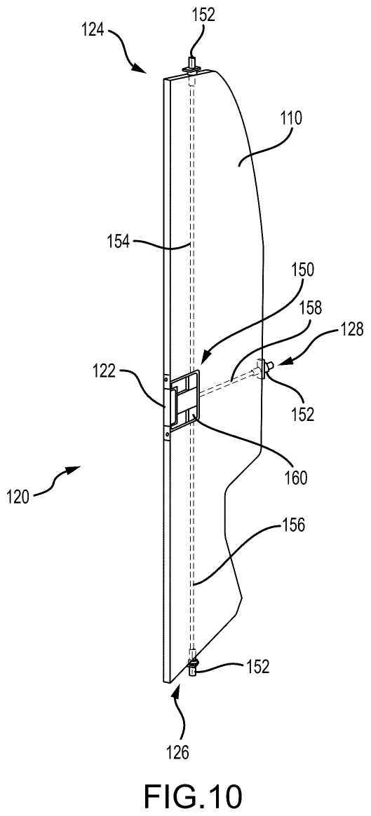

With respect to FIG. 10, an internal latch system 150 is illustrated. The internal latch system 150 provides the mechanical linkage that enables simultaneous operation of latches 130 from the single handle 122. The internal latch system 150 may comprise a handle system 160 operably coupled to the handle 122. The internal latch system 150 may comprise a first vertical rod 154 extending from the handle system 160 to the ceiling latch 124. The internal latch system 150 may comprise a second vertical rod 156 extending from the handle system 160 to the floor latch 126. The internal latch system 150 may comprise a horizontal rod 158 extending from the handle system 160 to the rear latch 128. Each rod of the first vertical rod 154, the second vertical rod 156, and the horizontal rod 158 may terminate in a pawl 152. Said another way, each latch 130 may comprise a pawl 152. Each pawl 152 may be configured to extend from the center wall 110 to latch the center wall 110 in place. Each pawl 152 may be dimensioned to extend into a channel 142 of a latch receiver 140. In various embodiments, each pawl 152 may be configured to retract within the perimeter of the center wall 110 in response to the handle 122 being pulled from the front edge 121 in the first direction D1. The rods 154, 156, 158 may be formed of a rigid material such as steel, aluminum, or rigid polymer to ensure reliable force transmission from the handle 122 to each pawl 152. In various embodiments, the latch system 120 may further comprise a biasing element (such as a spring) configured to bias the handle 122 toward the latched position, such that the pawls 152 remain extended unless the handle 122 is pulled in the first direction D1.

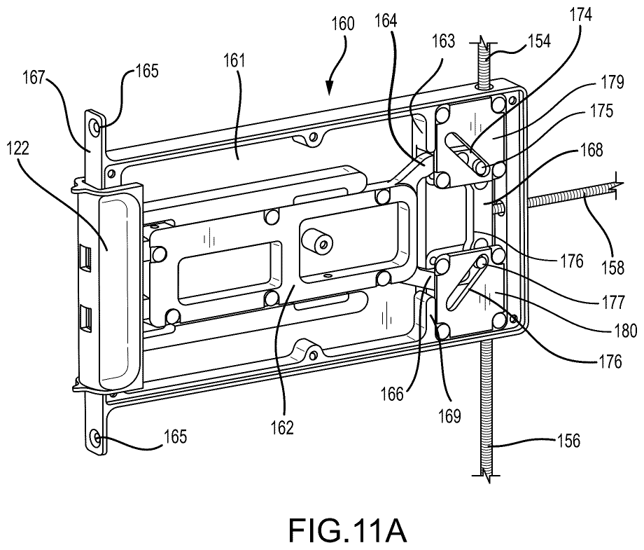

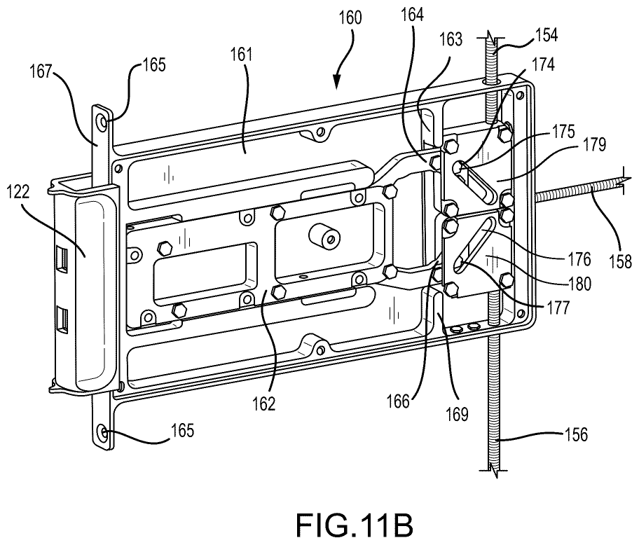

As illustrated in FIGS. 11A and 11B, a handle system 160 is illustrated. The handle system 160 converts the linear push/pull motion of the handle 122 into coordinated linear motion of the rods 154, 156, 158 to actuate latches 130 simultaneously. The handle system 160 may comprise a mounting face 167 extending from either side of the handle 122. The mounting face 167 may comprise various through-holes 165 for fastening the handle system 160 to the front edge 121 of the center wall 110. The handle system 160 may comprise an internal plate 161. The internal plate 161 may be fixedly secured to the center wall 110 and serves as a stationary reference against which the longitudinal member 162 translates. The handle system 160 may comprise a longitudinal member 162 operably coupling the handle 122 to each of the first vertical rod 154, the second vertical rod 156, and the horizontal rod 158. The longitudinal member 162 may be rigidly connected to the handle 122 such that pulling or pushing the handle 122 causes corresponding translation of the longitudinal member 162.

In various embodiments, a first strut 164 may be rigidly coupled to an upper portion of the longitudinal member 162. The first strut 164 may be coupled to the first vertical rod 154. First vertical rod 154 may be rigidly coupled to a first panel 179. First panel 179 may be slidable within a first groove 163 of longitudinal member 162. A first post 175 may extend perpendicularly from first strut 164. The first post 175 may extend through a first angled slot 174 of first panel 179. The first angled slot 174 may be oriented at an angle relative to the direction of handle travel such that lateral translation of the longitudinal member 162 is converted into vertical translation of the first vertical rod 154. In response to operation of handle 122, the longitudinal member 162 may translate with respect to the internal plate 161 and/or the first groove 163. In response to translation of the longitudinal member 162, the first post 175 may exert a force on the first panel 179 such that the first panel 179 translates in a vertical direction within the first groove 163 to allow the first post 175 to translate within the first angled slot 174. The angle of the first angled slot 174 determines the mechanical advantage and stroke length of the first vertical rod 154. In response, the first vertical rod 154 may be operated between an extended position in which the pawl 152 of the ceiling latch 124 protrudes from the center wall 110 and a retracted position in which the pawl 152 of the ceiling latch 124 is retracted within the center wall 110.

In various embodiments, a second strut 166 may be rigidly coupled to a lower portion of the longitudinal member 162. The second strut 166 may be coupled to the second vertical rod 156. Second vertical rod 156 may be rigidly coupled to a second panel 180. Second panel 180 may be slidable within a second groove 169 of longitudinal member 162. A second post 177 may extend perpendicularly from second strut 166. The second post 177 may extend through a second angled slot 176 of second panel 180. The second angled slot 176 may be oriented at an angle opposite to the first angled slot 174 such that translation of the longitudinal member 162 causes the second vertical rod 156 to translate in an opposite vertical direction from the first vertical rod 154. This opposing motion ensures that when the handle 122 is pulled, both the ceiling latch 124 and the floor latch 126 retract toward the center of the center wall 110, and when the handle 122 is pushed, both latches extend outward from the ceiling edge 125 and floor edge 127, respectively. In response to operation of handle 122, the longitudinal member 162 may translate with respect to the internal plate 161 and/or the second groove 179. In response to translation of the longitudinal member 162, the second post 177 may exert a force on the second panel 180 such that the second panel 180 translates in a vertical direction within the second groove 169 to allow the second post 177 to translate within the second angled slot 176. The angle of the second angled slot 176 determines the mechanical advantage and stroke length of the second vertical rod 156. In response, the second vertical rod 156 may be operated between an extended position in which the pawl 152 of the floor latch 126 protrudes from the center wall 110 and a retracted position in which the pawl 152 of the floor latch 126 is retracted within the center wall 110.

In various embodiments, the longitudinal member 162 may be coupled to the horizontal rod 158 via a beam 168. The beam 168 may extend between the first strut 164 and the second strut 166. The beam 168 may be rigidly or pivotably connected to the horizontal rod 158. Because the horizontal rod 158 extends in a direction parallel to the direction of handle travel (i.e., the first direction D1 and second direction D2), the coupling between the beam 168 and the horizontal rod 158 may be a direct linear coupling. In response to operation of handle 122, the longitudinal member 162 may translate with respect to the internal plate 161. Translation of longitudinal member 162 may cause translation of beam 168. The horizontal rod 158 may translate in response to translation of the beam 168. In various embodiments, the beam 168 may include a lost-motion connection or flexible coupling to accommodate manufacturing tolerances. In response, the horizontal rod 158 may be operated between an extended position in which the pawl 152 of the rear latch 128 protrudes from the center wall 110 and a retracted position in which the pawl 152 of the rear latch 128 is retracted within the center wall 110.

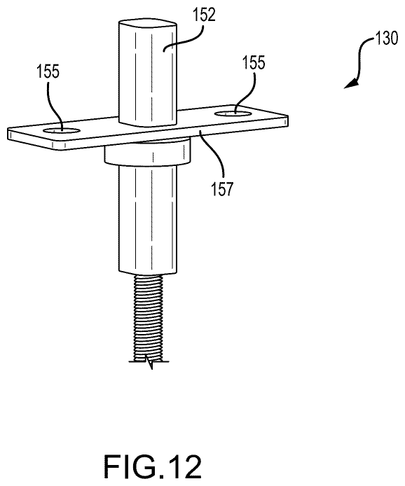

With respect to FIG. 12, a latch 130 is illustrated. Latch 130 may comprise a mounting plate 157. The mounting plate 157 may extend from either side of a pawl 152. The mounting plate 157 comprise various through-holes 155 for fastening the latch 130 to the center wall 110. The latch 130 may comprise a pawl 152 configured to translate with respect to the mounting plate 157.

Finally, it should be noted that while this disclosure is directed primarily to aircraft lavatory center walls, that the concepts described above can also be applied to doors for other aircraft compartments or for compartments within other vehicles or structures. For example, the latch system 120 may be operable to release and/or latch a storage compartment wall to various positions, a compartment wall on a train, a compartment wall on a bus, etc.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A latch system, comprising:
an internal plate;
a longitudinal member coupled to the internal plate;
a handle operably coupled to the longitudinal member such that the longitudinal member is configured to translate in response to operation of the handle; and
a first vertical rod operably coupled to the longitudinal member, the first vertical rod terminating in a first pawl, wherein, in response to operation of the handle, the first pawl may be extended and retracted with respect to the longitudinal member.

2. The latch system of claim 1, further comprising a center wall having a perimeter defined by a front edge, a rear edge, a ceiling edge, and a floor edge, wherein, in response to operation of the handle, the first pawl may be extended from the perimeter of the center wall and retracted within the perimeter of the center wall.

3. The latch system of claim 2, wherein the handle forms at least a portion of the front edge of the center wall.

4. The latch system of claim 1, wherein the internal plate defines a first angled slot and the first vertical rod is coupled to the internal plate via a first post extending through the first angled slot such that, in response to operation of the handle, the first angled slot guides translation of the first vertical rod.

5. The latch system of claim 4, further comprising a first claw coupling the longitudinal member to the first post.

6. The latch system of claim 1, further comprising a second vertical rod operably coupled to the longitudinal member, terminating in a second pawl, and extending from the longitudinal member in an opposing direction from the first vertical rod.

7. The latch system of claim 6, wherein the internal plate defines a second angled slot and the second vertical rod is coupled to the internal plate via a second post extending through the second angled slot such that, in response to operation of the handle, the second angled slot guides translation of the second vertical rod.

8. The latch system of claim 1, further comprising a horizontal rod operably coupled to the longitudinal member, terminating in a third pawl, and extending from the longitudinal member in a direction perpendicular to the first vertical rod.

9. An aircraft lavatory, comprising:
a center wall having a perimeter defined by a front edge, a rear edge, a ceiling edge, and a floor edge;
a first latch disposed on the ceiling edge and comprising a first pawl configured to extend from and retract into the ceiling edge;
a second latch disposed on the rear edge and comprising a second pawl configured to extend from and retract into the rear edge; and
a handle disposed on the front edge and configured to simultaneously operate the first latch and the second latch through a mechanical linkage comprising a longitudinal member that translates in response to actuation of the handle.

10. The aircraft lavatory of claim 9, further comprising:
an internal plate coupled to the handle;
a first vertical rod operably coupling the first pawl to the internal plate; and
a horizontal rod operably coupling the second pawl to the internal plate.

11. The aircraft lavatory of claim 9, wherein, in response to pulling the handle in a first direction away from the front edge of the center wall, the first pawl is translated in a second direction perpendicular to the first direction such that the first pawl is retracted within the ceiling edge.

12. The aircraft lavatory of claim 11, wherein, in response to pulling the handle in the first direction away from the front edge of the center wall, the second pawl is translated in the first direction such that the second pawl is retracted within the rear edge.

13. The aircraft lavatory of claim 12, wherein, in response to pushing the handle in a third direction opposite the first direction toward the front edge of the center wall, the first pawl is translated in a fourth direction opposite the second direction such that the first pawl is extended from the ceiling edge and the second pawl is translated in the third direction such that the second pawl is extended from the rear edge.

14. The aircraft lavatory of claim 9, wherein in response to retraction of the first pawl and the second pawl, the center wall is free to translate within the aircraft lavatory.

15. An aircraft lavatory comprising:
a first single lavatory;
a second single lavatory, wherein the aircraft lavatory is convertible between a dual lavatory configuration in which each of the first single lavatory and the second single lavatory are individually accessible and a single lavatory configuration in which the first single lavatory and the second single lavatory are accessible as an expanded lavatory;
a floor extending across the first single lavatory and the second single lavatory;
a ceiling extending across the first single lavatory and the second single lavatory;
a rear wall extending across the first single lavatory and the second single lavatory;
a center wall configured to separate the first single lavatory from the second single lavatory in the dual lavatory configuration and configured to translate within the aircraft lavatory to convert the first single lavatory and the second single lavatory into the single lavatory configuration; and
a latch system for latching the center wall into a center position in the dual lavatory configuration, the latch system comprising:
a first latch for coupling the center wall to the ceiling of the aircraft lavatory,
a second latch for coupling the center wall to the rear wall of the aircraft lavatory, and
a handle configured to simultaneously operate the first latch and the second latch through mechanical actuation, wherein actuation of the handle causes coordinated extension or retraction of pawls of the first latch and the second latch.

16. The aircraft lavatory of claim 15, wherein the handle is coupled to a midsection of the center wall and is inaccessible in response to either a first door of the first single lavatory or a second door of the second single lavatory being in a closed position.

17. The aircraft lavatory of claim 15, wherein the handle is disposed on a front edge of the center wall.

18. The aircraft lavatory of claim 17, wherein the ceiling comprises a first channel for receiving a first pawl of the first latch, and wherein the rear wall comprises a second channel for receiving a second pawl of the second latch.

19. The aircraft lavatory of claim 18, wherein the first pawl is configured to extend from the center wall into the first channel and the second pawl is configured to extend into the second channel in response to pushing the handle in a first direction toward the center wall, and wherein the first pawl is configured to retract into the center wall and the second pawl is configured to retract into the center wall in response to pulling the handle in a second direction away from the center wall.

20. The aircraft lavatory of claim 15, further comprising a third latch for coupling the center wall to the floor of the aircraft lavatory, wherein the handle is configured to operate the first latch, the second latch, and the third latch simultaneously.
